(19) United States
(12) Patent Application Publication
(10) Pub. No.: US 2024/0126589 A1
(43) Pub. Date: Apr. 18, 2024

(54) CUMULATIVE BALANCE ALGORITHM FOR CONSISTENT HASHING TOKEN SELECTION

(71) Applicant: Cloudian Holdings, Inc., San Mateo, CA (US)

(72) Inventors: Bharatendra Boddu, San Mateo, CA (US); Vinodh Sankaravadivel, San Mateo, FL (US); Hao Qin, San Mateo, CA (US)

(21) Appl. No.: 18/485,465

(22) Filed: Oct. 12, 2023

Related U.S. Application Data
(60) Provisional application No. 63/379,342, filed on Oct. 13, 2022.

(51) Int. Cl. G06F 9/455

(52) U.S. Cl. CPC G06F 9/45558; G06F 2009/45562

(57) ABSTRACT

For hash token selection a cumulative balance placement algorithm may take a list of new nodes to be added and allocate new virtual nodes to a token range to ensure that when adding M new nodes, the distance between two virtual nodes for the same new node will be at least M−1 virtual nodes. This node balancing improves the operation of the system as a whole by more efficient utilization of each node.

### PRIORITY

This application claims priority to Provisional Pat. App. No. 63/379,342, filed on Oct. 13, 2022, entitled “CUMULATIVE BALANCE ALGORITHM FOR CONSISTENT HASHING TOKEN SELECTION”, the entire disclosure of which is herein incorporated by reference.

### TECHNICAL FIELD OF THE INVENTION

The present invention relates to a system or method for consistent hashing with balancing for hash token selection.

### BACKGROUND

Consistent hashing is a hashing technique in distributed storage systems that allows the system to scale with a minimum amount of hash key movement. With N nodes and K keys, the average cost for redistribution of keys when adding or removing a node is O(K/N). In contrast, a simple hash function such as “modulo N” requires redistribution of all K keys when the N changes. Example distributed storage systems like Dynamo and Cassandra use a consistent hash function to map a data object to its node location where the object is stored. Example consistent hash functions are MD5 and Murmur3. Adding nodes to a cluster may be inefficient.

### BRIEF SUMMARY

The present invention relates to a method, system or apparatus and/or computer program product for adding nodes to a cluster by optimizing selection of virtual nodes to those nodes with cumulative balancing. For hash token selection a cumulative balance placement algorithm may take a list of new nodes to be added and allocate new virtual nodes to a token range to ensure that when adding M new nodes, the distance between two virtual nodes for the same new node will be at least M−1 virtual nodes.

There may be an algorithm or system that can measure an imbalance at individual nodes. The imbalance may be due to traffic distribution or other usage at the nodes. The goal may be to minimize any imbalance. In particular, the determination for the balancing may be part of a simulation for balancing. The simulation can be used for determining proper node distribution (e.g. number of nodes, capacity of nodes, etc.) which can be used to plan and predict future expansion. There may be a threshold value used such that any node that exceeds the threshold requires balancing. As described, there may be configurations that are considered for each node for the determination of balancing.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, like reference numerals designate corresponding modules or items throughout the different drawings.

FIG. 1 illustrates an example consistent hash ring with nodes.

FIG. 2 illustrates an example consistent hash ring with node selection.

FIG. 3 illustrates an example network system.

FIG. 4 illustrates an example hash token selection process.

FIG. 5 illustrates example configurations that are considered for the balancing.

### DETAILED DESCRIPTION OF THE DRAWINGS AND PREFERRED EMBODIMENTS

By way of introduction, the disclosed embodiments relate to systems and methods for adding nodes to a cluster by optimizing selection of virtual nodes to those nodes with cumulative balancing. For hash token selection a cumulative balance placement algorithm may take a list of new nodes to be added and allocate new virtual nodes to a token range to ensure that when adding M new nodes, the distance between two virtual nodes for the same new node will be at least M−1 virtual nodes.

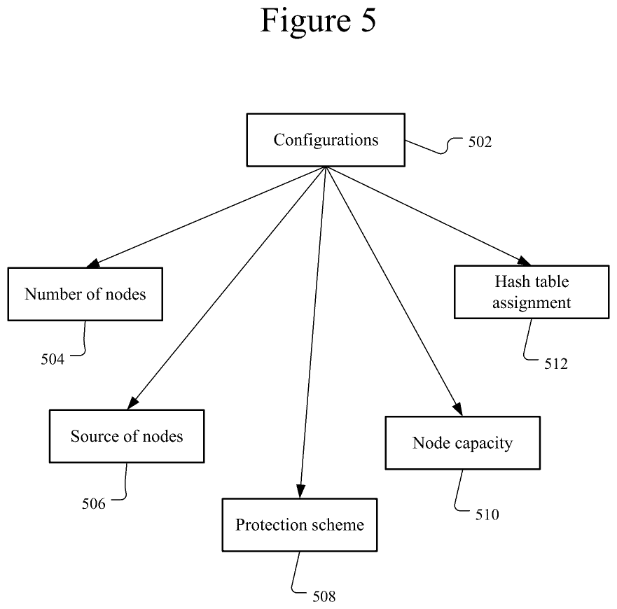

In one example, the node balancing may be for data centers with storage nodes. Each node may be optimized by running a simulation. The optimization may include the load balancing described herein. The optimization may be based on configurations discussed below with respect to FIG. 5.

### Consistent Hashing

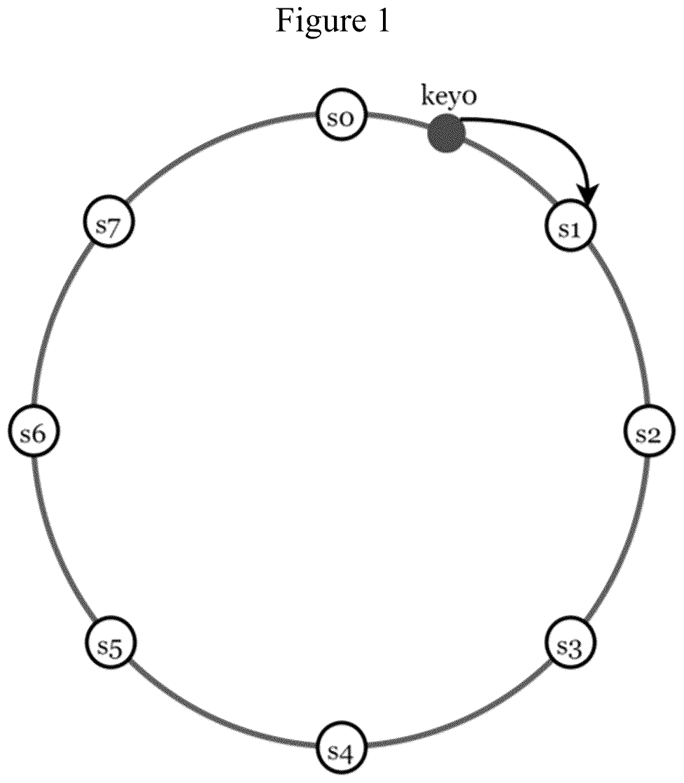

FIG. 1 illustrates an example consistent hash ring with nodes. A consistent hash function may determine for each key on which N nodes the key is stored. A hash value may be called a token. Each node may be assigned a value on the hash ring, and a token range is the region on the ring from the current token to the predecessor token. The keys whose hash values fall in the range are assigned to that node which owns the right end of the token range as shown in FIG. 1.

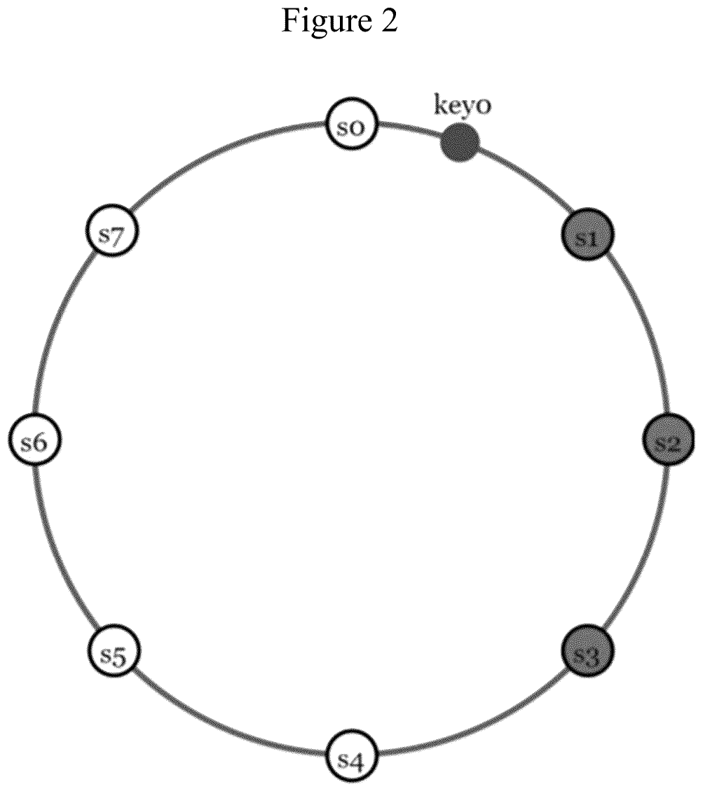

FIG. 2 illustrates an example consistent hash ring with node selection. For availability and durability reasons, the key may be stored on multiple N nodes using simple replication or erasure coding that can be identified by collecting a necessary number of nodes walking around in clockwise order on the consistent hash ring. In FIG. 2, s1, s2, and s3 are nodes for the key.

Instead of using N token ranges for the N nodes, there may be V virtual nodes where V>N and V token ranges where each virtual node is associated with a node. In some embodiments, nodes with different storage capacities can be accommodated by assigning relatively more virtual nodes to large nodes. One example of this assignment of virtual nodes is used in Cassandra.

When assigning the V virtual nodes to the hash ring, it may be necessary to distribute the request traffic (e.g., reads and writes) and/or storage amounts (i.e., bytes) evenly across the multiple nodes. Then, distributing the V virtual nodes uniformly across the token range may be one initial assignment strategy, assuming the data key hash function is uniformly distributed across the token range.

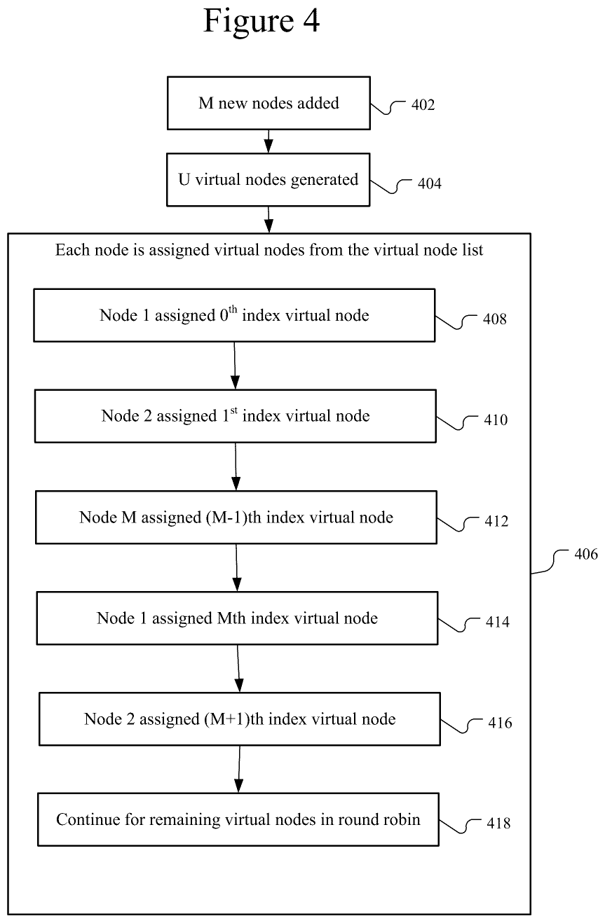

Virtual node assignment to the token range when additional nodes are added to a running system is discussed below with respect to FIG. 4. In this example, there may be an existing imbalance in the request traffic and/or storage amounts, and adding new virtual nodes is an opportunity to improve the balance. Rather than drawing from a random uniform distribution on the token space, a cumulative balance selection may be used. The cumulative balance selection may use information about the existing data and virtual node distribution. This virtual node-to-token assignment may be more effective in balancing future request traffic and/or storage amounts.

### Example Network System

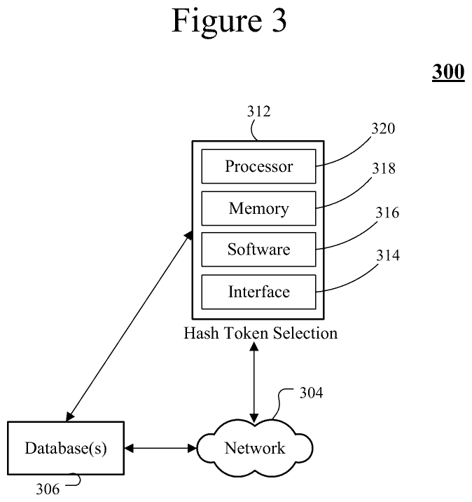

FIG. 3 illustrates an example network system 300. The system 300 may utilize the consistent hashing technique, including hash token selection with balancing as discussed below. In particular, the hash token selection 312 may perform hash token selection balancing for a distributed storage system. The distributed storage system may include one or more databases 306 over a network 304. In other embodiments, the database(s) 306 may also be connected directly with the hash token selection 312.

In one embodiment, the hash token selection 312 may be software that runs on a computing device as shown in FIG. 3. The hash token selection 312 is further described with respect to FIG. 4. Specifically, FIG. 3 illustrates example components of the hash token selection 312 and FIG. 4 illustrates an example process flow. As described, the hash token selection may be part of the consistent hashing technique described with respect to FIGS. 1-2.

The hash token selection 312 may be one or more components for performing consistent hashing and/or hash token selection balancing. The hash token selection may include a processor 320, a memory 318, software 316, and/or a user interface 314. In alternative embodiments, the hash token selection 312 may be multiple devices to provide different functions and it may or may not include all of the user interface 314, the software 316, the memory 318, and/or the processor 320. In some embodiments, the hash token selection 312 may be implemented in software on a distributed network system.

The interface 314 may be a user input device or a display. The user interface 314 may include a keyboard, keypad or a cursor control device, such as a mouse, or a joystick, touch screen display, remote control or any other device operative to allow a user or administrator to interact with the hash token selection 312. The user interface 314 may communicate with any of the systems in the network 304, including the hash token selection 312 or any other components in a distributed network system. The user interface 314 may include a user interface configured to allow a user and/or an administrator to interact with any of the components of the hash token selection 312 for providing access and functionality for consistent hashing and/or hash token selection balancing. The user interface 314 may include a display coupled with the processor 320 and configured to display an output from the processor 320. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 320, or as an interface with the software 316 for providing data.

The processor 320 in the hash token selection 312 may include a central processing unit (CPU), a graphics processing unit (GPU), a digital signal processor (DSP) or other type of processing device. The processor 320 may be a component in any one of a variety of systems. For example, the processor 320 may be part of a standard personal computer or a workstation. The processor 320 may be one or more general processors, digital signal processors, application specific integrated circuits, field programmable gate arrays, servers, networks, digital circuits, analog circuits, combinations thereof, or other now known or later developed devices for analyzing and processing data. The processor 320 may operate in conjunction with a software program (i.e. software 316), such as code generated manually (i.e., programmed). The software 316 may include a process for consistent hashing and/or hash token selection balancing.

The processor 320 may be coupled with the memory 318, or the memory 318 may be a separate component. In some embodiments, there may not be a memory 318 as part of the hash token selection 312, which hashes data in separate database(s) 306. In some embodiments, the software 316 may be stored in the memory 318. The memory 318 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 318 may include a random access memory for the processor 320. Alternatively, the memory 318 may be separate from the processor 320, such as a cache memory of a processor, the system memory, or other memory. The memory 318 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 318 is operable to store instructions executable by the processor 320.

The functions, acts or tasks illustrated in the figures and/or described herein may be performed by the programmed processor executing the instructions stored in the software 316 or the memory 318. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 320 is configured to execute the software 316.

The present disclosure contemplates a computer-readable medium that includes instructions or receives and executes instructions responsive to a propagated signal, so that a device connected to a network can communicate voice, video, audio, images or any other data over a network. The user interface 314 may be used to provide the instructions over the network via a communication port. The communication port may be created in software or may be a physical connection in hardware. The communication port may be configured to connect with a network, external media, display, or any other components in system 300, or combinations thereof. The connection with the network may be a physical connection, such as a wired Ethernet connection or may be established wirelessly as discussed below. Likewise, the connections with other components of the system 300 may be physical connections or may be established wirelessly.

Any of the components in the system 300 may be coupled with one another through a (computer) network, including but not limited to the network 304. In some embodiments, the system may be referred to as a distributed storage system for storing and hashing data. The network 304 may be a local area network (“LAN”), or may be a public network such as the Internet. Accordingly, any of the components in the system 300 may include communication ports configured to connect with a network. The network or networks that may connect any of the components in the system 300 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

### Hash Token Selection Balancing

Adding one node at a time sequentially and doubling the capacity of the cluster to minimize the utilization imbalance may be inefficient. In some embodiments, cumulative balance selection may be one example for virtual node-to-token range assignment that is more effective in balancing future request traffic and/or storage amounts. The balancing may be based on any of the configurations described with respect to FIG. 5.

The cumulative balance placement algorithm takes the list of new nodes to be added and allocates new virtual nodes to the token range. This may ensure that when adding M new nodes, the distance between two virtual nodes for the same new node will be at least M−1 virtual nodes. This distance of at least M−1 virtual nodes can help with storing the keys from other nodes efficiently and thereby provide a better balance of data in the cluster. In contrast, adding virtual nodes of a single new node at a time at random, there is more likely that two virtual nodes can end up in the same token range. In this embodiment, there is an assignment of virtual nodes (vnodes) for all the new nodes.

FIG. 4 illustrates an example hash token selection process. Specifically, the cumulative balance selection is used for assigning virtual nodes. The list of new nodes M to be added is provided as input in block 402. A number of virtual nodes U is generated in block 404. For example, if M=5 and 100 virtual nodes are assigned per node, then U=500. In block 406, each node will then be assigned virtual nodes from the virtual node list in a round robin structure. In block 408, node 1 will get the 0th index virtual node. In block 410, node 2 will get the 1st index virtual node. In block 412, node M will get the (M−1)th index virtual node. In block 414, node 1 will get Mth index virtual node. In block 416, node 2 will get an (M+1)th index virtual node. In block 418, this round robin structure can continue for all additional virtual nodes to be assigned. This method can result in each virtual node for a node being at least separated by M−1 virtual nodes from its next virtual node.

There may be additional constraints on the virtual node placement. For example, there may be location constraints such as a data center or rack affinity. In these examples, the additional constraints are applied in addition to the process illustrated in FIG. 4. For example, when adding nodes to a data center, there may be a consideration of the token ranges that belong to the same data center and place the virtual nodes in those ranges.

FIG. 5 illustrates example configurations 502 that may be considered for the balancing. Specifically, the algorithm or system considers one or more of these configurations 502 to determine which nodes are balanced and how they are balanced. The number of nodes available 504 may be considered. For example, fewer nodes may require more extensive balancing to relieve the load. There may be nodes added during an expansion. The source of the nodes 506 may include a particular data center that a node is assigned to. Different data centers may have different balancing requirements or conditions. The protection scheme 508 may include the types of protections for the data center and/or nodes. This scheme may be a constraint that for the possible balancing. The capacity of each node 510, including different capacities may be utilized for determining which nodes need balanced and how they are to be balanced. An increase in node storage capacity may require different balancing as individual nodes may handle more load. This node capacity may also include individual disc capacity for examples where a node has multiple discs. Each individual disc capacity may be used for the balancing rather than the node capacity. The hash tokens may be per disc rather than per node, and may be distributed equally among discs, or may be distributed based on disc capacity. The hash tokens may be assigned to virtual nodes in block 512. As described the number of virtual nodes may be increased to reduce the hash. The imbalance is determined for this increase in virtual nodes and balancing among node usage can improve performance.

The meaning of specific details should be construed as examples within the embodiments and are not exhaustive or limiting the invention to the precise forms disclosed within the examples. One skilled in the relevant art will recognize that the invention can also be practiced without one or more of the specific details or with other methods, implementations, modules, entities, datasets, etc. In other instances, well-known structures, computer-related functions or operations are not shown or described in detail, as they will be understood by those skilled in the art.

The discussion above is intended to provide a brief, general description of a suitable computing environment (which might be of different kinds like a client-server architecture or an Internet/browser network) in which the invention may be implemented. The invention will be described in the general context of computer-executable instructions, such as software modules, which might be executed in combination with hardware modules, being executed by different computers in the network environment. Generally, program modules or software modules include routines, programs, objects, classes, instances, components, data structures, etc., that perform particular tasks or implement particular abstract data types. Computer-executable instructions, associated data structures and program modules represent examples of the program code means for executing steps of the method described herein. The particular sequence of such executable instructions, method steps or associated data structures only represent examples of corresponding activities for implementing the functions described therein. It is also possible to execute the method iteratively.

Those skilled in the art will appreciate that the invention may be practiced in a network computing environment with many types of computer system configurations, including personal computers (PC), hand-held devices (for example, smartphones), multi-processor systems, microprocessor-based programmable consumer electronics, network PCs, minicomputers, mainframe computers, laptops and the like. Further, the invention may be practiced in distributed computing environments where computer-related tasks are performed by local or remote processing devices that are linked (either by hardwired links, wireless links or by a combination of hardwired or wireless links) through a communications network. In a distributed computing environment, program modules may be located in local or remote devices, memory systems, retrievals or data storages.

Generally, the method according to the invention may be executed on one single computer or on several computers that are linked over a network. The computers may be general purpose computing devices in the form of a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in clinical/medical system environments. The system memory includes read-only memory (ROM) and random access memory (RAM). A basic input/output system (BIOS), containing the basic routines that have the functionality to transfer information between elements within the computer, such as during start-up, may be stored in one memory. Additionally, the computer may also include hard disc drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick or a mouse. Additionally, interfaces to other systems might be used. These and other input devices are often connected to the processing unit through a serial port interface coupled to the system bus. Other interfaces include a universal serial bus (USB). Moreover, a monitor or another display device is also connected to the computers of the system via an interface, such as a video adapter. In addition to the monitor, the computers typically include other peripheral output or input devices (not shown), such as speakers and printers or interfaces for data exchange. Local and remote computers are coupled to each other by logical and physical connections, which may include a server, a router, a network interface, a peer device or other common network nodes. The connections might be local area network connections (LAN) and wide area network connections (WAN) which could be used within the intranet or internet. Additionally, a networking environment typically includes a modem, a wireless link or any other means for establishing communications over the network.

Moreover, the network typically comprises means for data retrieval, particularly for accessing data storage means like repositories, etc. Network data exchange may be coupled by means of the use of proxies and other servers.

The example embodiments are to be considered in all respects only as illustrative and not restrictive. The scope of the invention is, therefore, indicated by the appended claims rather than by this description. All changes which come within the meaning and range of equivalency of the claims are to be embraced within their scope.

1. A method for hash token selection comprising:
identifying new nodes to be added to existing nodes;
generating virtual nodes to correspond with the nodes; and
assigning each of the virtual nodes to the nodes in a round robin structure.

2. The method of claim 1, wherein the virtual nodes correspond with the new nodes.

3. The method of claim 2, wherein the round robin structure corresponds with each of the virtual nodes being assigned to a corresponding one of the new nodes sequentially.

4. The method of claim 2, wherein the round robin structure allocates the virtual nodes to a token range.

5. The method of claim 4, wherein when adding M new nodes, a distance between two of the virtual nodes for one of the new nodes is at least M−1 virtual nodes.

6. The method of claim 5, wherein the round robin structure comprises assigning node 1 a 0th index virtual node, and assigning node 2 a 1st index virtual node.

7. The method of claim 1, wherein the generating or assigning considers a determination of configurations.

8. The method of claim 7, wherein the configurations comprise at least one of a number of the nodes, a source of the nodes, a protection scheme, a node capacity, or a hash table assignment.

9. A method for cumulative balance selection comprising:
identifying nodes to be rebalanced among existing nodes;
generating virtual nodes to correspond with the identified nodes; and
assigning each of the virtual nodes to the nodes in a round robin structure such that node M will get the (M−1)th index virtual node.

10. The method of claim 9, wherein the round robin structure allocates the virtual nodes to a token range.

11. The method of claim 10, wherein when adding M new nodes, a distance between two of the virtual nodes for one of the new nodes is at least M−1 virtual nodes.

12. The method of claim 11, wherein the round robin structure comprises assigning node 1 a 0th index virtual node, and assigning node 2 a 1st index virtual node.

13. The method of claim 9, wherein the virtual nodes correspond with the identified nodes.

14. The method of claim 9, wherein the round robin structure corresponds with each of the virtual nodes being assigned to a corresponding one of the identified nodes sequentially.

15. The method of claim 10, wherein the generating or assigning considers a determination of configurations.

16. The method of claim 15, wherein the configurations comprise at least one of a number of the nodes, a source of the nodes, a protection scheme, a node capacity, or a hash table assignment.
